(19) United States
(12) Patent Application Publication
(10) Pub. No.: US 2009/0220201 A1
(43) Pub. Date: Sep. 3, 2009

(54) Fiber-optic arrangement for display devices, in particular having analog or digital displays, and devices provided therewith

(75) Inventors: Steffen Reichel, Mehlingen (DE); Burkhard Danielzik, Bingen (DE); Kevin Tabor, Webster, MA (US); Michael Weisser, Southbridge, MA (US)

Correspondence Address: DeMont & Breyer, LLC, 100 Commons Way, Ste. 250, Holmdel, NJ, 07733, US

(73) Assignee: SCHOTT AG, 55122 Mainz (DE)

(21) Appl. No.: 11/817,614

(22) PCT Filed: Mar. 14, 2006
(86) PCT No.: PCT/EP06/02336

§ 371 Date: Aug. 4, 2008

(30) Foreign Application Priority Data
Mar. 14, 2005 (DE) 10 2005 011 956.5

(51) Int. Cl. G02B 6/06

(52) U.S. Cl. 385/116

(57) ABSTRACT

The invention relates to a transparent arrangement for a display device, in particular for an analog and/or digital display, having a fiber-optic arrangement which transmits light from an entry face into an exit face, wherein regions, in particular pixels, of an image field lying in front of the entry face are visible on the exit face of the fiber-optic arrangement, and regions visible on the exit face, in particular pixels are spatially offset relative to the image field at least by an offset V.

The invention relates to a fiber-optic arrangement for display devices, in particular for devices comprising analog or digital displays, in general and to devices provided therewith.

It is known to guide light in light-guiding devices for signaling or display purposes.

U.S. Pat. No. 6,690,623 B1 describes time display devices which comprise fiber-optic light guides, in order to display the current time on a display face, in particular a dial plate, by means of light emerging from the fibers.

Fiber-optic devices, for example fiber-optic plates, have already been used in order to increase the observation angle of liquid crystal displays and to improve their homogeneity, as described for example in EP 0 674 209 A1.

Displays with organic light-emitting diodes, i.e. OLED displays, have already been provided with fiber-optic plates, which is described in EP 1 385 219 A1.

It is an object of the invention to further improve the visibility of the display device, in particular an analog or digital display.

This is already achieved in a surprisingly effective way by a transparent arrangement for a display device having the features of claim 1 and by a display device having the features of claim 26.

With the transparent arrangement for a display device, in particular for an analog and/or digital display, having a fiber-optic arrangement which transmits light from an entry face into an exit face, wherein regions, in particular pixels, of an image field lying in front of the entry face are visible on the exit face of the fiber-optic arrangement, and regions visible on the exit face, in particular pixels are spatially offset relative to the image field at least by an offset V, the viewing plane can be moved forwards, which means that the visually perceptible position of the display can be arranged optically closer to the observer and edge shadows due to housing regions can be avoided.

In a surprisingly simple way, an analog or digital display's image field lying deeper in the housing can thereby be moved forwards into an image plane on the surface of the housing of the display device. The display can be optically perceived essentially without an offset from the housing surface, which gives the observer the impression that the image field lies in a plane or at least peripherally flush in the plane of the housing surface.

This provides great design latitudes in particular for applications which require high reliability, high strength and/or also shielding action. The actual arrangement of the analog or digital display can be arranged deeply in the housing of a housing form which is mechanically robust or has a strong shielding effect in terms of radiation, while the visually perceptible position of the image of the display device still lies on the surface. Furthermore, there is substantially more space for sealing devices or for lateral fastening devices compared with known display screens.

Another property of the transparent fiber-optic arrangement, which is very advantageous for many applications, consists in the aperture angle of the light emerging from the light-guiding fiber, which can be adjusted within wide limits. This angle can be influenced merely by selection of the numerical aperture of the light-guiding fiber on its exit face. This exit angle may furthermore be influenced strongly by a spherical or even aspherical configuration of the fiber end face.

Depending on the setting of this aperture angle, display devices can therefore be provided which can still be seen laterally up to an observation angle of almost 90°, which means up to almost parallel observation relative to the light exit face.

Alternatively it is extremely advantageously possible to provide narrow light regions, substantially lobe-shaped intensity distributions of the emerging light, which ensure substantially improved visibility even in smoke, fog or highly contaminated air.

Because light is scattered by particles of smoke or fog as well as particulate contaminants, for example in an aircraft cockpit the light fraction scattered in a pilot's viewing direction is substantially less in such a case, since lateral light intensity is extending transversely to the pilot's viewing direction and also their scattering intensities are greatly reduced. The contrast of the display devices improved according to the invention consequently remains substantially higher even in case of hazard, and allows more reliable navigation in and control of exceptional situations.

This however offers considerable advantages not only in aviation, for example avionic instruments, but also in other vehicles or even in the chemical industry in security areas or hazardous areas. In particular fibers consisting of glass or comprising glass are in this case substantially more suitable than for example plastic fibers, in order to ensure correct functioning of the display device even under heavy thermal loading as well as under chemical attack.

The image field may furthermore have a different maximum observation angle in a first direction, for example in the horizontal direction, than in a second direction, for example in the vertical direction, which allows even better adaptation to the respective requirements.

To this end it is advantageous for the fiber-optic arrangement to be a fiber-optic plate having a first multiplicity of light-transmitting fibers essentially arranged mutually parallel, preferably having at least one proportion of glass fibers or consisting of glass fibers.

A fiber which, with the exception of coloring absorption bands, transmits more than 70% of the light entering its entry face to its exit face at least in a spectral range of the visual spectrum of light from 380 nm to 750 nm, will in this case be used as a transmitting fiber or light-transmitting fiber.

If the numerical aperture NAa of a transparent fiber in a preferred embodiment has the value 1.0 on its exit face, this provides observation angles of up to 90° which are advantageous for many applications. Particularly with fiber-optic plates which comprise an outwardly curved exit face, visibility is thereby constantly ensured for the entire visible part of the fiber-optic plate for virtually all observation angles.

In many cases, however, it may be highly advantageous for the numerical aperture NAa of a transparent fiber on its exit face to have a value which is less than 1.0, since, for manufacturing the optical fibers, it is then possible to employ materials which have a smaller refractive index difference between the fiber core and the fiber cladding and which are less susceptible to generating colorations by absorption bands.

For many applications, the numerical aperture NAa of a transparent fiber on its exit face is preferably 0.7+/−0.3 and most preferably has a value of less than 0.9. In particular with the most preferred value of 0.85, typical observation angles in a range of approximately 58° can be produced which are entirely sufficient for many applications.

According to another embodiment of the invention, however, it is also possible to use smaller numerical apertures. The numerical aperture NA of fibers of the fiber-optic arrangement in this case preferably lies in the range of from 0.3 to 0.7. In order to achieve a good resolution even under sizeable observation angles with fibers having a smaller numerical aperture as well, it is advantageous for light-scattering structures to be arranged at or on the exit face. In this way it is even possible to achieve observation angles which are greater than the value dictated by the numerical aperture. In this refinement of the invention, it is advantageous in particular for the light-scattering structures to be provided only on the observation or light exit side, but not on the light entry side.

Such light-scattering structures may, for example, be produced by roughening the exit face. Alternatively or in addition, a scattering disk may be arranged on the exit face. Light-scattering structures in this embodiment, in the context of the invention, are intended to mean structures which modify the angle distribution of the light, and in particular broaden it relative to the refraction by a plane or uniformly curved surface. This also includes the fraction of light by a non-plane interface, for instance by structures with a curved or facetted surface. Accordingly, besides a roughened surface, for example, small lenses on the light exit-side fiber end may also cause light scattering and magnify the observation angle. The embodiment of the invention with light-scattering structures is not restricted to fiber-optic arrangements with a small numerical aperture of the fibers, but may of course also be used and lead to an improvement even with sizeable values of the numerical aperture of the fibers.

For avionic or nautical instruments or instruments in the safety sectors, however, narrower maximum observation angles of for example 10° of 15° may also be highly advantageous, for example in order to send light only to an observer located at a defined position, to which end the numerical aperture NAa may then assume values of approximately 0.3+/−0.2, particularly preferably 0.174 or 0.26.

When using fiber-optic plates with fibers whose diameter increases with dense fiber packing from their entry face to their exit face, the resulting image on the exit face of the fiber-optic arrangement may be represented with a magnified size, which is of great advantage for many applications owing to the better visibility.

For designed reasons or in the event of stringent structural conditions, when using fiber-optic plates with fibers whose diameter decreases with dense fiber packing from their entry face to their exit face, the resulting image on the exit face of the fiber-optic arrangement may be represented with a reduced size.

The resulting image in the fiber-optic arrangement's image plane lying on the exit face may furthermore be rotated relative to the image at the position of the image field of the display, if the fiber bundle of the fiber-optic plate comprises a rotation.

If the fiber-optic arrangement comprises a second multiplicity of light-absorbing fibers essentially arranged parallel to the first multiplicity of transmitting fibers, then scattered light emerging laterally from the fiber cladding can thereby be reduced and the contrast of the image on the exit face can therefore be increased, so that a substantially improved visual sharpness impression is created.

A fiber which causes absorption by at least 15%, preferably by more than 50% for light laterally entering the fiber perpendicularly to the fiber, preferably in the entire range of the visual spectrum, and at the position of the greatest diameter of the fiber with a single transit, is regarded as an absorbing fiber in this case.

For many display applications, it may be advantageous for at least some of the absorbing fibers to define a window, since different display regions can thereby be demarcated in a contrast-rich way. A similar effect may also be achieved by the transparent arrangement additionally or alternatively comprising a mask.

Because of mechanical stability, it is possible to provide the transparent arrangement at least preferably with a fastening element, so that it can be mounted in a self-supporting fashion without further components or modules. Elements from the group which comprises depressions, elevations, a screw threads and bayonet components, are in this case advantageous as peripheral fastening elements.

The transparent arrangement may furthermore comprise peripheral recesses for sealing elements, so as to directly permit fluid-tight seating in the mounted state in an extremely simple way.

Self-sealing material-fit seating in the mounted state is facilitated when the transparent arrangement comprises conical side faces or conical screw threads.

If the fiber end of a transmitting fiber has a non-plane shape on its entry and/or exit side, then the respective numerical aperture can thus be advantageously influenced by refraction.

If the first multiplicity of transmitting fibers comprises at least fibers having a first core diameter and fibers having a second core diameter, the first core diameter being different from the second core diameter, then the brightness can thus advantageously be improved by fibers with a larger core diameter and the contrast by fibers with a smaller core diameter. Furthermore, for example, high image brightness may be provided for a narrow observation angle range by a first group of fibers and lower image brightness for a larger observation angle range by fibers of a second group. The choice of the numerical ratio of the various fibers between one another, and of their core diameter, allows further optimization for the respective requirements.

Design effects can advantageously be implemented if at least some of the transmitting fibers have a coloring effect in the visible part of the spectrum, and in particular comprise transmission and/or absorption bands.

Further attractive design effects may also be achieved if the at least locally non-plane surface is shaped ellipsoidally or pyramidally. In the case of a pyramidal configuration, the respective facets of the pyramids may also be assigned their own image regions of the image field of a display, so as to create a display device which is laterally visible sector-wise.

For the design of the display device, it may furthermore be highly advantageous for the offset V at least in a side section of the exit face of the fiber-optic arrangement to correspond approximately to the distance from an edge section of the image field of a display or its display members to a housing edge, neighboring the fiber-optic arrangement, of a housing of the display device.

The offset V relative to the width or the diameter of the fiber-optic plate is more than 0.01 times the width or the diameter, preferably more than 0.1 times the width or the diameter and most preferably more than 0.2 times the width or the diameter. In this case, the width is understood to be the smallest lateral width, for example the width with the respectively smallest dimension in a polygonal fiber-optic arrangement.

Good image quality is insured if the display device comprises an image field having a smallest structure size S, in particular having a display member with the smallest structure size S, having a distance L between the entry face of the transparent arrangement and the image field, in particular a distance L between the entry face of the transparent arrangement and the display member, wherein the fiber core diameter of a plurality or all of the transmitting fibers is d, the plurality or all of the transmitting fibers have a numerical aperture NAₑ on the entry face of the transparent arrangement, and the distance L satisfies: L≦(S−d)/(2·tan [arcsin(NAe)]).

With a parallel arrangement of the entry face of the fiber-optic arrangement to the surface of the image field of the display, the distance L means the average distance from the entry face to the surface of the image field or, in a non-parallel arrangement, the maximum distance from the entry face to at least 70% of the surface of the image field, in each case measured starting from a point of the entry face, perpendicularly to the entry face, to the point of the image field thereby encountered.

In a display device comprising an image field having a smallest structure size S, in particular having a display member with the smallest structure size S, having a distance L between the entry face of the transparent arrangement and the image field, in particular a distance L between the entry face of the transparent arrangement and the display member, wherein the fiber core diameter of a plurality or all of the transmitting fibers is d, the plurality or all of the transmitting fibers have a numerical aperture NAe on the entry face of the transparent arrangement,
i) if the fiber core diameter d of a plurality of or all the optical fibers of the first multiplicity of fibers satisfies d≦(S−2·L·tan [arcsin(NAe)])/2, then an image quality still satisfactory for standard applications will be achieved,
ii) if preferably the fiber core diameter d of a plurality of or all the optical fibers of the first multiplicity of fibers satisfies the relation d≦(S−2·L·tan [arcsin(NAe)])/3, then a very good image quality is obtained, and
iii) if the fiber core diameter d of a plurality of or all the optical fibers of the first multiplicity of fibers particularly preferably satisfies the relation d≦(S−2·L·tan [arcsin(NAe)])/5, then this allows a very high-grade image quality.

In general, however, a fiber core diameter will be preferred which has the greatest diameter still tolerable for the respective application, in order to maintain a maximally large distance L with a maximally sharp image on the exit face of the fiber-optic device.

For the above relations, it is advantageous for a maximum observation angle â of the display device that the numerical aperture of a fiber on its exit face NAa should be designed so that NAa=cos(â) is satisfied and preferably NAa=NAe, where â is the angle as measured from a normal to the exit face at the position of the fiber core to the direction of the observation.

In an embodiment which is simple in terms of manufacturing technology and preferred for cost reasons, the numerical aperture of a transparent fiber on its entry face NAe corresponds approximately to the numerical aperture of the fiber on its exit face NAa.

Particularly good image quality is provided by a fiber-optic arrangement, which is also part of an imaging device, when for example the fiber-optic arrangement is part of the cavity of an LCD display and conductive structures or thin-film transistors are arranged on its entry face, or the fiber-optic arrangement is part of the cavity of a plasma display.

For many applications, the transparent arrangement may advantageously have a scratch-protection layer and/or a layer reducing reflections on its exit face and/or on its entry face.

The invention will be described in more detail below with the aid of preferred embodiments and with reference to the appended drawings, in which:

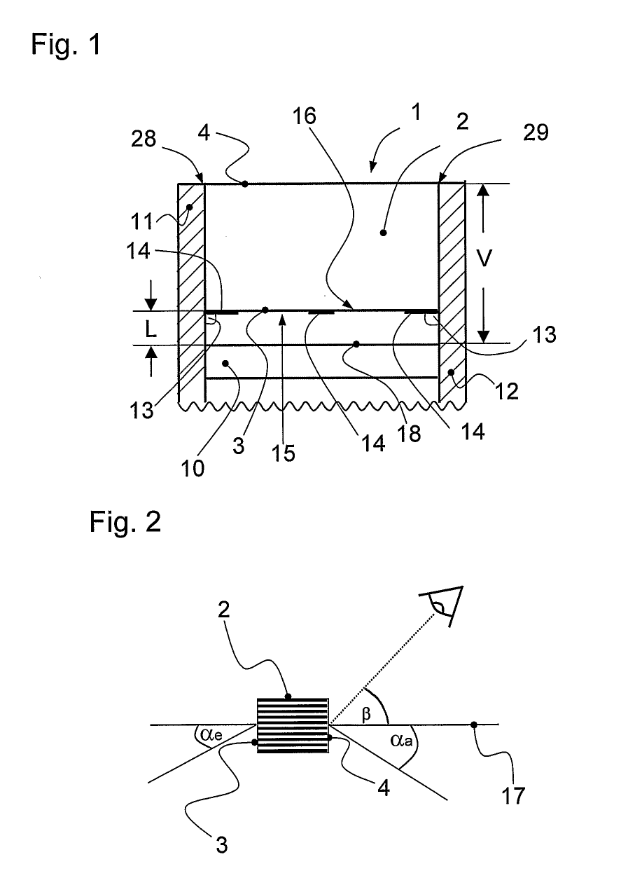

FIG. 1 shows a part of a first embodiment of a display device according to the invention with a first embodiment of a fiber-optic arrangement partially represented in cross section,

FIG. 2 shows a schematic representation of an observer of a fiber-optic arrangement in order to define the observation angle â relative to the fiber-optic arrangement,

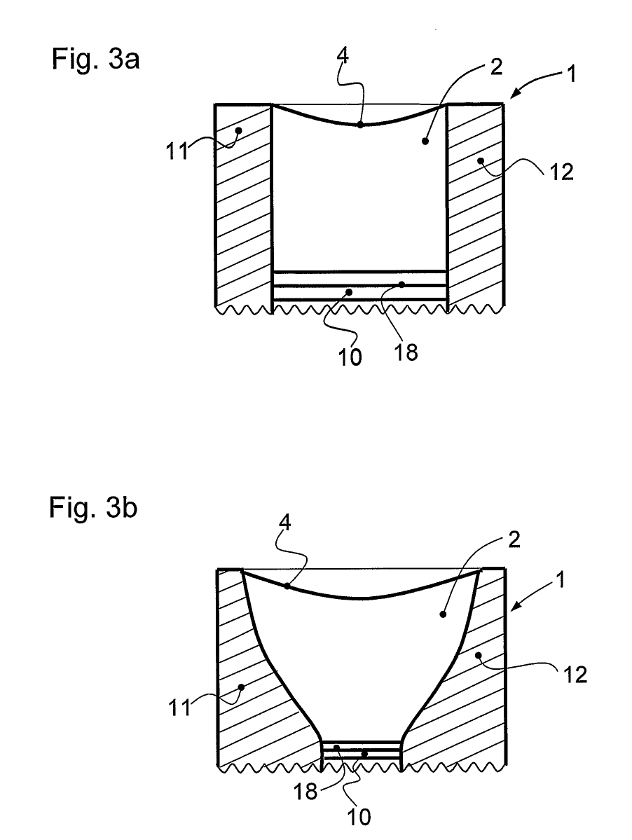

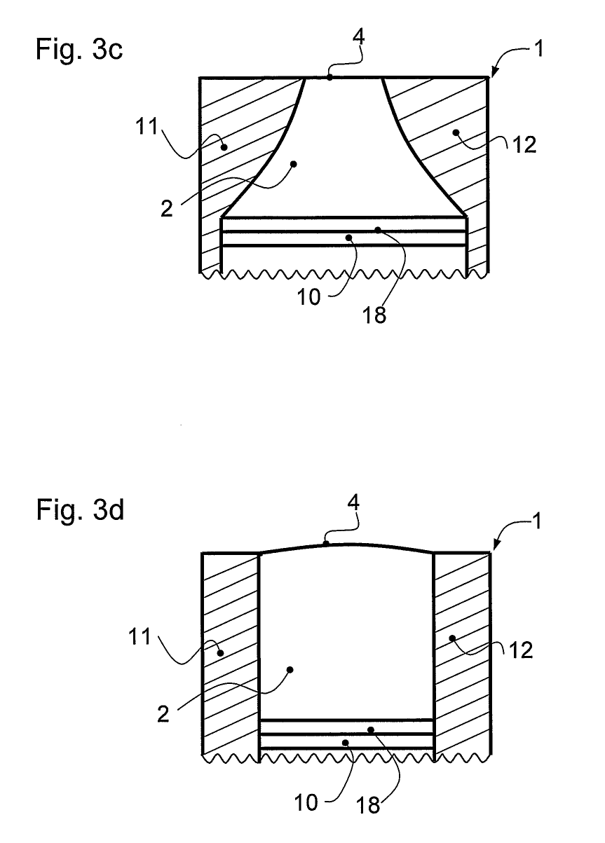

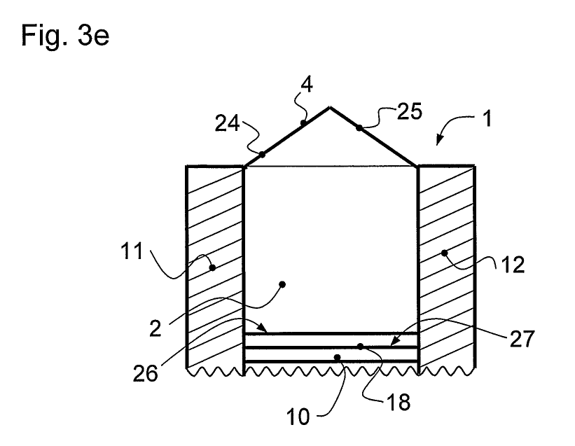

FIG. 3a shows a part of a second embodiment of a display device according to the invention with a second embodiment of a fiber-optic arrangement partially represented in cross section, in which the exit face is concavely shaped,

FIG. 3b shows a part of a third embodiment of a display device according to the invention with a third embodiment of a fiber-optic arrangement partially represented in cross section, in which the fiber-optic arrangement has a magnifying effect and the exit face is concavely shaped,

FIG. 3c shows a part of a fourth embodiment of a display device according to the invention with a fourth embodiment of a fiber-optic arrangement partially represented in cross section, in which the fiber-optic arrangement has a size-reducing effect,

FIG. 3d shows a part of a fifth embodiment of a display device according to the invention with a fifth embodiment of a fiber-optic arrangement partially represented in cross section, in which the fiber-optic arrangement comprises a convex exit face,

FIG. 3e shows a part of a fifth embodiment of a display device according to the invention with a fifth embodiment of a fiber-optic arrangement partially represented in cross section, in which the fiber-optic arrangement comprises a pyramidal exit face,

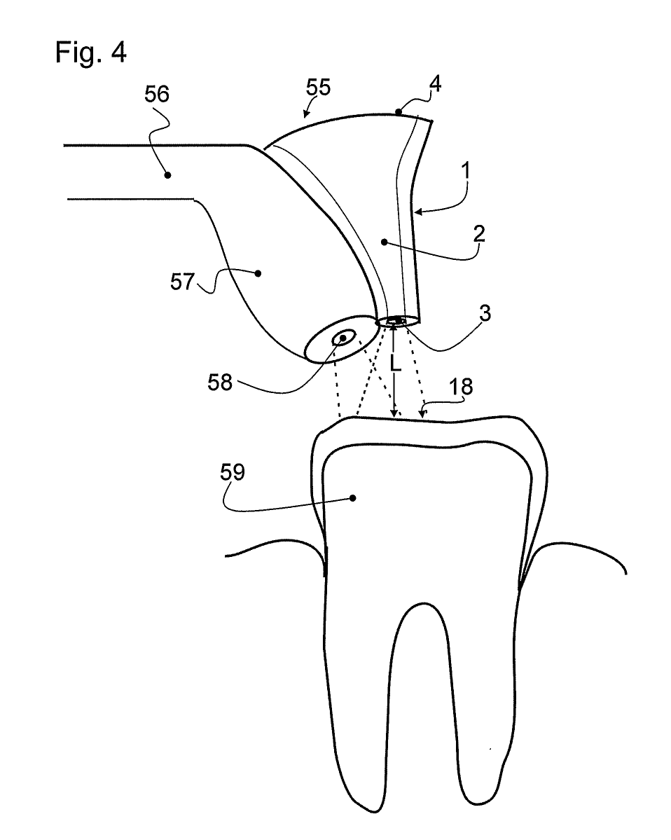

FIG. 4 shows a part of a medical instrument, a device for dental treatment in particular for the youth the curing of plastic implants, having another embodiment of a fiber-optic arrangement represented partially represented in cross section,

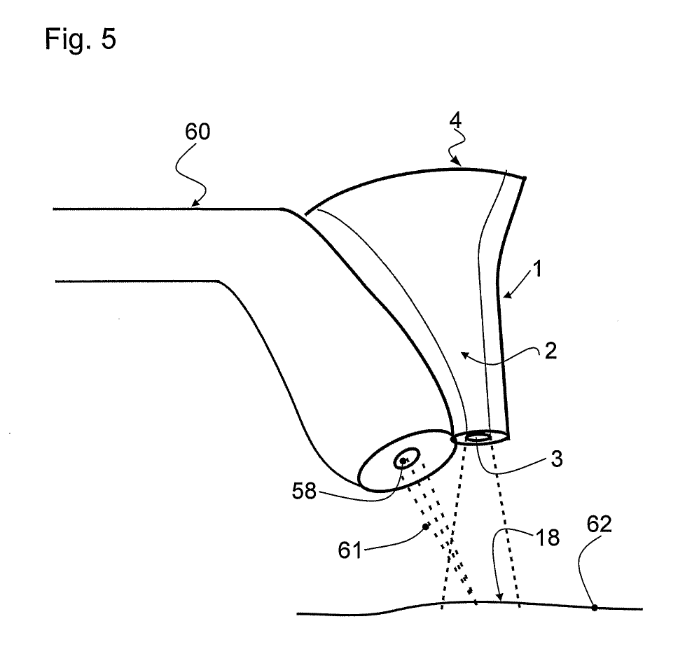

FIG. 5 shows a part of another medical instrument, a device for laser surgery in particular for microinvasive surgery, having another embodiment of a fiber-optic arrangement represented partially represented in cross section,

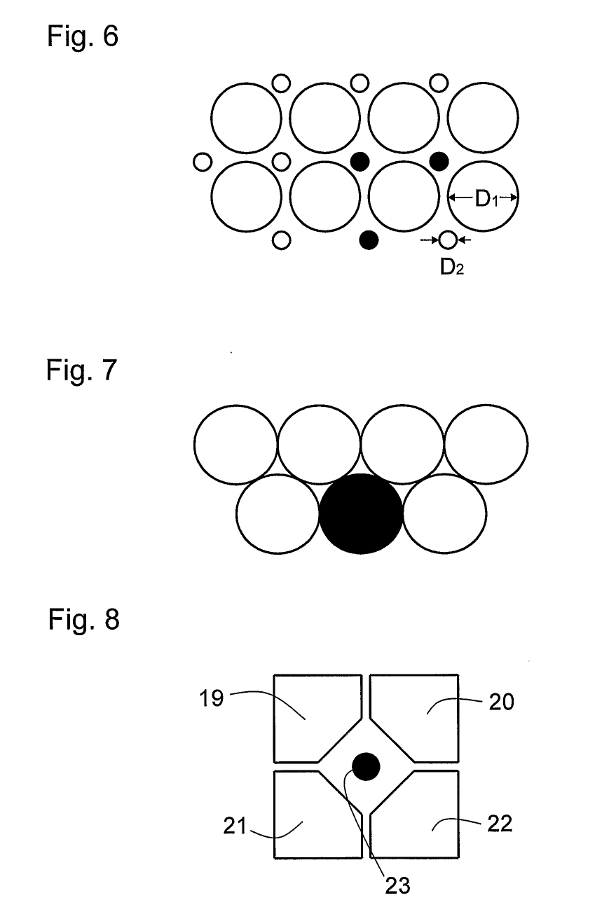

FIG. 6 shows a plan view of the exit face of yet another embodiment of a fiber-optic arrangement, having fibers with two different fiber diameters and in particular fiber core diameters,

FIG. 7 shows a plan view of the exit face of yet another embodiment of a fiber-optic arrangement, having fibers in the densest packing,

FIG. 8 shows a plan view of the exit face of yet another embodiment of a fiber-optic arrangement, having fibers to which an absorbing fiber is assigned group-wise,

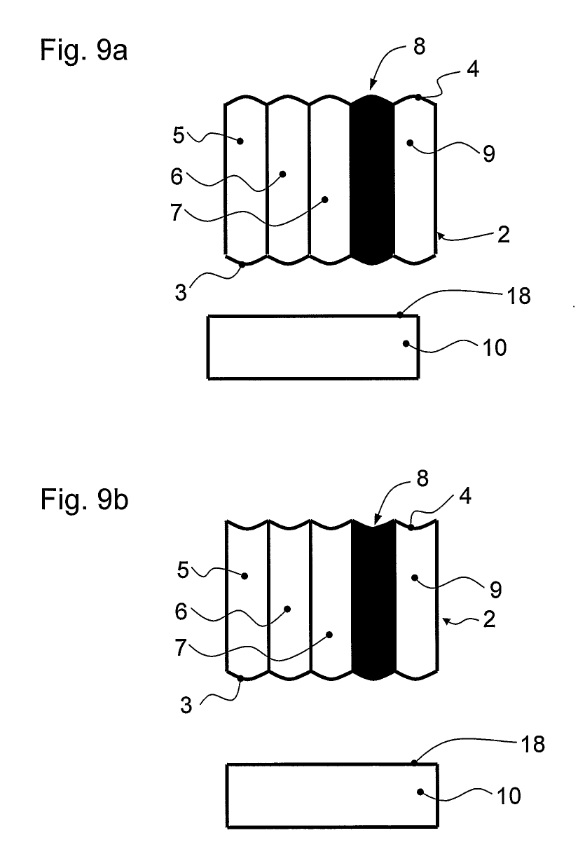

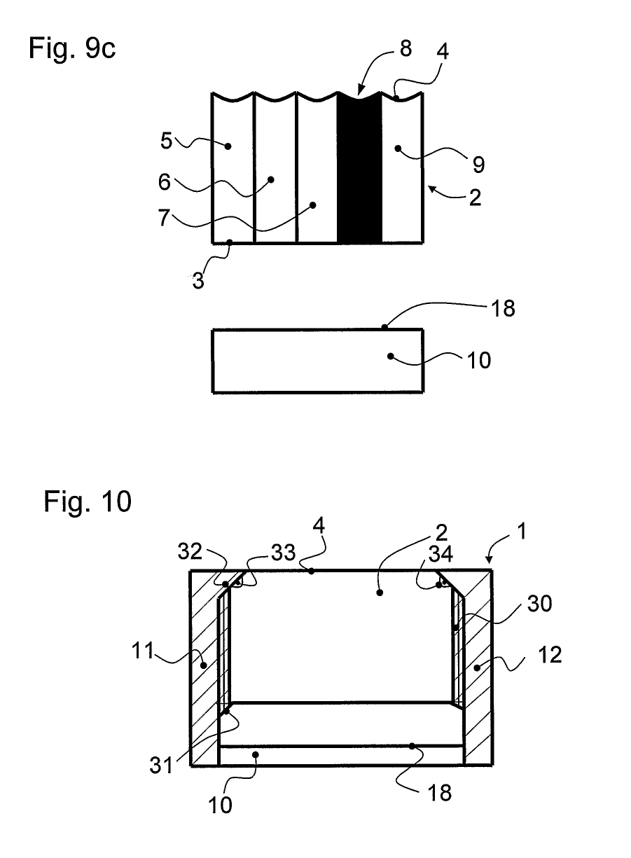

FIG. 9a shows a part of another embodiment of a fiber-optic arrangement partially represented in cross section, in which the fiber-optic arrangement comprises fibers with convex entry and exit faces,

FIG. 9b shows a part of another embodiment of a fiber-optic arrangement partially represented in cross section, in which the fiber-optic arrangement comprises fibers with a convex entry face and a concave exit face,

FIG. 9c shows a part of another embodiment of a fiber-optic arrangement partially represented in cross section, in which the fiber-optic arrangement comprises fibers with a plane entry face and a concave exit face,

FIG. 10 shows a part of another embodiment of a display device according to the invention with another embodiment of a fiber-optic arrangement partially represented in cross section, in which the fiber-optic arrangement comprises a lateral fastening means and recesses for sealing elements,

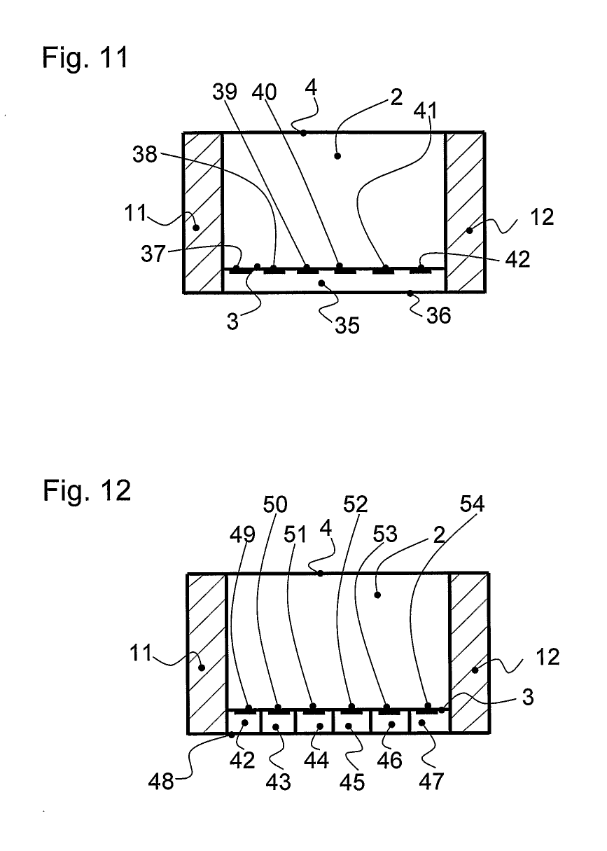

FIG. 11 shows a part of another embodiment of a display device according to the invention with another embodiment of a fiber-optic arrangement partially represented in cross section, in which the fiber-optic arrangement is part of the cavity of an LCD display and conductive structures or thin-film transistors are arranged on its entry face,

FIG. 12 shows a part of another embodiment of a display device according to the invention with another embodiment of a fiber-optic arrangement partially represented in cross section, in which the fiber-optic arrangement is part of the cavity of a plasma display,

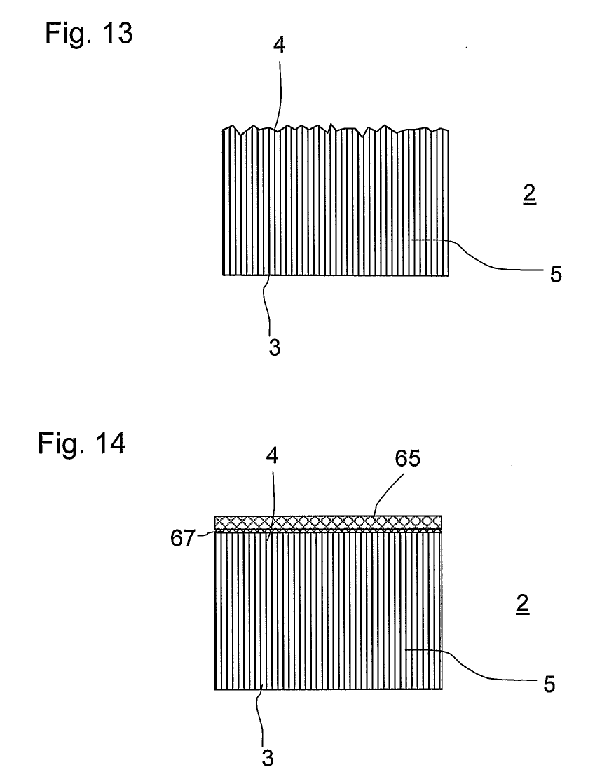

FIG. 13 shows a fiber-optic arrangement with light-scattering structures, and

FIG. 14 shows a variant of the exemplary embodiment shown in FIG. 13 with a separate scattering disk.

### DETAILED DESCRIPTION OF PREFERRED EMBODIMENTS

In the following detailed description of preferred embodiments of the invention, the same references are respectively used for components of the various embodiments which are essentially functionally equivalent or identical.

The representations in the figures are furthermore not true to scale, in order to assist better understanding. Also, for the sake of clarity not all structures are always fully represented, for example in the various fiber bundle arrangements in which the fiber cladding or fiber core cannot always been seen, but instead their mutual relative position.

Reference will be made below to FIG. 1 which shows a part of the first embodiment of a display device according to the invention, denoted overall by 1, with a first embodiment of a fiber-optic arrangement 2 partially represented in cross section.

The fiber-optic arrangement 2, which will be described in more detail in the following section, comprises an entry face 3 and an exit face 4 between which a fiber bundle, for example as represented in FIGS. 9a to 9c with the fibers 5, 6, 7, 8 and 9, extend while being arranged substantially parallel to one another.

Unless otherwise indicated in the following description, the entry and exit faces of the respective individual fibers of the fiber-optic arrangement 2 also lie in this entry face 3 and this exit face 4 respectively, that is to say except for deviations due to their non-plane configuration.

The fiber-optic arrangement 2 comprises a fiber-optic plate, which is held at a distance L in front of a display 10 bilateral housing elements 11, 12 of the display device 1. This display 10 may be an analog display with pointers or a digital display with separately drivable pixels, for example as in an LCD, an OLED or a plasma display.

In the case of a digital display, the smallest lateral dimension of such a separately drivable pixel will be regarded as the smallest structural size S. In an analog display, the smallest structural size S is correspondingly that image information in the image field of the display 10 or of its display member, which is still intended to be represented well-visibly on the exit face 4.

The display 10 is advantageously designed to be self-illuminating, for example such as an OLED or plasma display or, if it is transparent, comprises backlighting which is known to the person skilled in the art and consequently not represented in the figures.

It is furthermore within the scope of the invention to apply lighting means 13 in the region of the inner wall of the housing elements 11 and 12, which illuminate the surface facing the fiber-optic arrangement 2, and therefore the image field of the display 10, for example as LEDs, discharge lamps or electroluminescent lighting means.

The lighting means 13 in the embodiment represented in FIG. 1 are arranged in front of a mask 14, which prevents direct light incidence of the light coming from these lighting means into the fiber-optic arrangement 2. The mask 14 arranged on the entry face of the fiber-optic arrangement 2 furthermore defines viewing windows 15 and 16, which are respectively assigned to regions of the display 10 that lie underneath and delimit these regions from one another with high contrast.

Alternatively or in addition, absorbing fibers 8 which likewise lead independently or additionally to lateral delimitation of different display regions, may be arranged in the regions lying directly behind the mask 14, see for example FIGS. 9a to 9c.

Although a very wide variety of materials of the light guides may be used according to the invention, at least a proportion of glass fibers is used in the fiber-optic arrangement 2, and in the most preferred embodiment of fibers consist of glass, with the absorbing fibers and the transmitting fibers.

In the manner known to the person skilled in the art, these fibers comprise a cladding and a core, so that light is guided in the fiber core owing to the refractive index difference between the cladding and core materials. Depending on the refractive index difference of the cladding and core materials, however, it is possible to guide the light only up to a maximum critical angle the value of whose sine is also referred to as the numerical aperture NA.

The observation angle â for a fiber-optic plate is schematically represented in FIG. 2, which shows a fiber-optic arrangement 2 in which the fibers extend in a horizontal direction and which shows by way of example on a fiber the largest angle, determined by the refractive index difference between the fiber core and the fiber cladding, from a normal 18 of the entry face 3 at which light can still be guided in the fiber. This maximum angle may have a different value áe on the entry side than on the exit side áa, for example when the fiber interfaces have a non-plane configuration as can be seen in FIGS. 9a to 9c.

The observation angle â is given as that angle which leads from a normal 17 at a point of the exit face 4 to that straight line which connects the root of the normal 17 to the observer's eye.

The sine of the maximum entry angle áₑ is referred to as the numerical aperture of the entry face NAe. Regions of the image field 18 of the display 10 that lie within this maximum angle áₑ are transmitted in a respective fiber of the fiber-optic arrangement 2 as a separate image point from its entry face into its exit face.

At an observation angle â which is less than the numerical aperture angle á₉ of the fibers on the exit face 4, these image structures lying in front of the entry face 3 visible as respectively separate image points on the exit face of the respective fiber.

This leads to imaging of these image points on the exit face 4 of the fiber-optic device 2 for pixels of the display, which are typically arranged in an image field 18, and regions or pixels of the image field 18 lying in front of the entry face 3 are displayed while being separated from the image field 18 by an offset V.

In the embodiments represented in FIG. 1 and in the further figures, the offset V is preferably selected so that an upper side section of the exit face 4 of the fiber-optic arrangement 2 corresponds substantially to the distance from an edge section of the image field 18 of the display 10, lying below it, to the in a housing edge of 28, 29 of the housing element 11 or 12.

The offset V relative to the width for the diameter of the fiber-optic plate is preferably less than 3 times the width or the diameter, preferably less than 2 times the width or the diameter and most preferably less than the width or the diameter itself.

The core diameter of a plurality or all of the optical fibers of the first multiplicity of fibers is preferably greater than or equal to 2 μm, in particular for applications with very high resolution and with extremely high quality, or is preferably greater than or equal to 10 μm, in particular for applications with very high resolution and with good quality, or is particularly preferably greater than or equal to 30 μm, in particular for applications with good quality, and is most preferably greater than or equal to 60 μm, in particular for applications with acceptable quality.

All sizes lying between these specified values may also be used according to the invention and, for example, for many applications a core diameter of 50 μm is even advantageous for display applications.

The inventors have discovered that the distance L between the entry face 4 of the fiber-optic arrangement 2 and the image field 18 of the display 10 should not be greater than the value of L given by the following equation: L≦(S−d)/(2·tan [arcsin(NAe)]), where the fiber core diameter of a plurality or at least all of the transmitting fibers, which crucially contribute to the image representation inside an observation angle range, has the value d.

As a function of the smallest structure size S, for a known value of L and S the diameter of the preferred fiber core d of a fiber may likewise be determined by the numerical apertures NAa and NAe, and it is advantageous that for a maximum observation angle â of the display device, the numerical aperture of a fiber on its exit face NAa should be designed so that cos(â) is satisfied and preferably NAa=NAe.

For an image field with a smallest structure size S, it in particular having a display member with the smallest structure size S, with a distance L between the entry face 3 of the transparent arrangement 2 and the image field 18, in particular a distance L between the entry face 3 of the transparent arrangement 2 and a display member, the fiber core diameter d of a plurality or all of the optical fibers of the first multiplicity of fibers is then a ratio d≦(S−2·L·tan [arcsin(NAe)])/2, preferably d≦(S−2·L·tan [arcsin(NAe)])/3, and in particular d≦(S−2·L·tan [arcsin(NAe)])/5.

An image quality still sufficient for standard applications is achieved by fulfilling the relation d≦(S−2·L·tan [arcsin(NAe)])/2, a very good image quality is achieved with d≦(S−2·L·tan [arcsin(NAe)])/3, and a very high-grade image quality is made possible by d≦(S−2·L·tan [arcsin(NAe)])/5.

Here, fiber core diameters d greater than or equal to 2 μm would be highly suitable for applications with very high resolution and with extremely high quality, diameters greater than or equal to 10 μm for applications with very high resolution and with good quality, fiber core diameters greater than or equal to 30 μm for applications with good quality, and core diameters greater than or equal to 60 μm for applications with acceptable quality.

The numerical aperture NAa of the transparent fibers on their exit face 4 preferably has a value of 0.7±0.3, and most preferably has a value which is less than 0.9.

A particularly preferred value of 0.85 defines a maximum observation angle â of up to approximately 58°.

For particular applications, for example in order to send light only to an observer located at a defined position, numerical apertures NAa of the transparent fibers on their exit face of approximately 0.3+/−0.2, particularly preferably 0.174 or for instance 0.26 may be used, which lead to maximum aperture angles respectively of 10° and 15°.

Besides the refractive index difference between the fiber core and the fiber cladding, the configuration of the fiber end face also has an influence on the aperture angle as represented in FIGS. 9a to 9c, and in the representation according to FIG. 9a which shows an embodiment of a fiber-optic arrangement partially in cross section, in which the fiber-optic arrangement comprises two fibers with convex entry and exit faces, a reduction in the numerical aperture takes place both on the entry face and on the exit face.

With the above relations, for a particular application with a known just resolvable structure size S, the greatest possible fiber diameter may thus be determined first, then the smallest numerical apertures still needed for this application may be ascertained and the allowed distance L may be established.

Reference will be made below to the fiber-optic arrangement 2 represented in FIG. 9b, in which the fiber-optic arrangement 2 comprises fibers with a convex entry face and a concave exit face so that a reduction in the numerical aperture takes place on the entry face and an increase in the numerical aperture takes place on their exit face, so that even smaller pixels of the image field 18 of the display 10 can be resolved or a larger distance L is made possible and larger observation angles â are obtained.

The embodiment represented in FIG. 9c may also be used advantageously, for example in order to permit an increased observation angles â with the increased numerical aperture on the exit face 4.

The shape of the respective ends of the fibers 5 to 9 may be spherical or aspherical and, for example, obtained by different etching rates of the fiber cladding and fiber core materials.

As represented merely very schematically in FIG. 6, instead of an equal core diameter for all fibers, a number of fibers may for example have a first diameter D1 and a further number of fibers may have a second diameter D2, which is less than the first core diameter.

Furthermore, as represented in a highly schematized way in FIG. 7, the fibers may be arranged in densest packing and exhibit an essentially identical diameter.

The invention is furthermore not restricted to round fibers, rather, as represented in FIG. 8 with the fibers 19 to 22, rectangular or generally polygonal fibers may also be employed. Advantageously, with the pentagonal fiber geometry of the fibers in FIG. 8, an absorbing fiber 23 is respectively assigned to four transmitting fibers.

In the fiber arrangement represented in FIG. 8 the image field may also have a different maximum observation angle in a first direction, for example in the horizontal direction, than in a second direction, for example in the vertical direction, which may be achieved by structuring the material of the fiber cladding during the production of the fiber, so that light is guided at a different critical angle than vertically. Alternatively or in addition, the surface of the fiber may have a different curvature horizontally and vertically on the exit face 4, for example as a result of directionally selective etching during its production.

The transmitting fibers may furthermore have a coloring effect, preferably in the visible part of the spectrum, and comprise corresponding transmission and absorption bands, preferably owing to the addition of dyes.

Furthermore, as represented in FIGS. 3a, 3b, 3d and 3e, the exit face 4 of the fiber-optic arrangement 2 may also be designed to be non-plane.

FIG. 3a shows a second embodiment of a fiber-optic arrangement 2, which is represented partially in cross section and in which the exit face 4 is concavely shaped so that an inwardly curved image field is provided, which is for example less sensitive to lateral scattered light.

Furthermore, as represented in FIG. 3d, the exit face 4 of the fiber-optic device 2 may also be shaped convexly outwards so that the design of the display device 2 can be deliberately influenced or, for example for displays in nautical devices, these can be made mechanically more stable so that they can withstand a higher pressure.

If the exit face 4 is designed pyramidally as shown in the embodiment represented in FIG. 3e, then the respective pyramid and faces 24, 25 may respectively be assigned narrow regions 26 or 27 of the image field 18 that light below this face.

In this way, separate display regions can be provided sector-wise for different regions of the image field 18 which are assigned to the respective pyramid sides.

In another configuration of the invention, the exit face 4 of the fiber-optic arrangement 2 may also be designed to be ellipsoidally concave or convex.

In another preferred embodiment, which is represented in FIG. 3b, the resulting image on the exit face 4 of the fiber-optic arrangement 2 is magnified relative to the image of the image field 13, which is achieved by modifying the size of the fiber core diameter.

In the embodiment represented in FIG. 3c, the resulting image on the exit face 4 of the fiber-optic arrangement 2 is reduced in size relative to the image in the image field 18 of the display, which is achieved by a size modification of the fibers of the fiber-optic arrangement 2 from larger to smaller diameters.

In another embodiment according to the invention, which is not separately represented in the figures, the fibers of the fiber-optic arrangement 2 are rotated relative to one another along their longitudinal direction, so that the image on the exit face 4 of the fiber-optic arrangement 2 is also rotated relative to the image at the position of the image field 18 of the display 10.

Another preferred embodiment is represented in FIG. 10, which shows another embodiment of the display device 1 according to the invention with another embodiment of the fiber-optic arrangement 2 partially in cross section.

The fiber-optic arrangement 2 in this embodiment comprises peripheral fastening elements 30, which comprise a screw thread applied on the outer circumference of the fiber-optic arrangement 2 in the embodiment represented in FIG. 10.

The screw thread 30 is screwed during assembly into an internal screw thread 31 of the housing elements 11, 12. This screw thread 30 and alternatively also the internal screw thread 31, preferably in the case of resilient plastic housing elements 11, 12, may be designed conically so that a self-sealing fit is directly achieved.

The exit face 4 is chamfered towards the side, preferably at an angle of 45°, and in the case of screw threads which are not self-sealing preferably comprises a recess 34, in particular an annular groove 34, in which a sealing element is accommodated for example in the form of a washer ring 33.

When the fiber-optic arrangement 4 is being screwed into the housing, the washer ring 33 comes to bear in a sealing fashion on the chamfered annular shoulder 32 of the housing and therefore seals the fiber-optic arrangement 2 fluid-tightly from the housing.

Instead of the screw thread, depressions or elevations which cooperate in bayonet fashion with assigned respectively or elevations and depressions on the housing elements 11, 12, and which ensure firm seating of the fiber-optic arrangement 2, may also be arranged as fastening elements in the fiber-optic arrangement 2.

Alternatively or in addition, an adhesive bond may be formed between the fiber-optic arrangement 2 and the housing elements 11, 12.

Reference will be made below to FIG. 11, in which another embodiment of the display device according to the invention is shown with another embodiment of the fiber-optic arrangement partially in cross section.

In this embodiment, the fiber-optic arrangement 2 is part of the cavity 35 of a liquid crystal display 36.

In a first such embodiment, transparent and two-dimensionally structured electrodes consisting of indium tin oxide (ITO) are arranged on the entry face 33 and are connected to drive the devices (not shown that the figures) so that pixels of the liquid crystal display 36 can be driven separately from one another.

Alternatively or in addition to or instead of the electrodes 37 to 41, thin-film transistors may be arranged on the entry face 3 of the fiber-optic arrangement 2 in order to actively drive the pixels of the liquid crystal display 36.

In the embodiment represented in FIG. 12, the fiber-optic arrangement 2 also forms a part of the cavities 42 to 47 of a plasma display 48 and separate electrodes 49 to 54, preferably at least one per cavity, are arranged in the respective cavity on the exit face 4 of the fiber-optic arrangement 2. The electrodes 49 to 54 are electrically driven so that they can separately induce a plasma discharge with a respective further backing electrode (not shown in the figures) in the individual cavities 42 to 47.

The transparent arrangement according to the invention may nevertheless also be used for displaying other analog image fields 18, for example of treatment fields in the medical sector.

Reference will be made below to FIG. 4 which shows a part of a medical instrument, specifically a device 55 for dental treatment, in the present case for the UV curing of plastic implants.

This medical instrument comprises a handle 56 on which a slightly angled-off head 57, which carries the display device according to the invention, is arranged.

On the other end of the head 57 from the handle, there is a light exit opening 58 from which light suitable for the curing of plastic emerges, for example ultraviolet light, and arrives conically on the tooth 59 to be treated.

This surface to be treated forms the image field 18 for the display device 1, which reproduces a magnified image of the treated toothed part in the region of the image field 18 on its exit face 4.

In the embodiment represented in FIG. 4, the fibers of the fiber-optic arrangement 2 may be designed convexly on the entry face 3 and concavely on the exit face 4 as represented in FIG. 9b, so as to allow an increased distance L and greater observation angle.

Alternatively or in addition, a lens or a lens system, which images the image field 18 onto the entry face 3, may be arranged in front of the entry face 3 of the fiber-optic arrangement 2.

Instead of an ultraviolet light source, a modified embodiment may comprise a light source with a high intensity component in the infrared spectral range, for example for heat therapy.

In yet another modified embodiment, the light source is adapted in its intensity and with its emission spectrum to dermatological requirements for the removal of tattoos or for skin treatment, in particular for rejuvenation therapy.

Reference will be made below to FIG. 5, which shows a part of another medical instrument in which parallel or focused light with high intensity emerges from the light exit opening 58.

The medical instrument 60 is a laser scalpel, which makes it possible to vaporize or cut regions of tissue 62 with the high light intensity of the light beam 61.

The display device 1 creates a magnified image on the exit face 4 of the fiber-optic device 2 which makes it possible, particularly in the case of microinvasive surgery, to remove tissue parts with high precision and thereby operate with minimal damage.

By selecting fibers which have a small numerical aperture NAe on the entry face 3 of the fiber-optic arrangement 2, a strong directional effect is achieved with little lateral light components when imaging the image field 18, so that scattered light is avoided during the treatment, in particular during the vaporization of tissue and thereby created gases with particulate components, so that improved contrast is achieved for the image of the exit face 4 of the fiber-optic arrangement 2.

Depending on the application, the transparent or fiber-optic arrangement 2 has a scratch-protection layer on its exit face 4 and/or on its entry face 3 in order to make it possible, for example in the medical instruments described above, to clean or disinfect them but without deteriorating their optical properties during prolonged use. In addition or alternatively, one or more layers reducing reflections are arranged on the exit face 4 and/or on the entry face 3.

FIG. 13 represents another exemplary embodiment of a fiber-optic arrangement 2. In this exemplary embodiment, the light exit side 4 is provided with light-scattering structures. To this end, the light exit side 4 is roughened. Scattering of the emerging light rays takes place owing to the roughened surface, so that some of them are deviated even from angles less than the numerical aperture angle into angles which are greater than the angle, defined by the numerical aperture NA of the fibers 5, at which image structures lying in front of the entry face 3 are otherwise just visible as separate image points at the fiber ends on the exit side. In this way, it is even possible to use more cost-effective fibers 5 with a lower numerical aperture, for example with a numerical aperture in the range of from 0.3 to 0.7.

FIG. 14 shows a variant of the exemplary embodiment of a fiber-optic arrangement 2 shown in FIG. 13. In the variant represented in FIG. 14 a separate scattering disk 65, which comprises light-scattering structures 67 on the side facing the fiber bundle, is placed onto the exit face 4. Similarly as in the example shown in FIG. 13, the light-scattering structures may be produced by reckoning the surface. Likewise, however, it is also possible to use a scattering disk having microlenses. Furthermore, the light-scattering structures may also be arranged in the volume of the scattering disk.

The invention is not restricted to the embodiments described above, rather it may be advantageously implemented in other embodiments, for example in the form of a motor vehicle instrument, in particular as a tachometer, r.p.m. counter or multifunctional display. The advantages according to the invention are also useful as an avionics instrument or instrument for an aircraft, for example as an altimeter, airspeed indicator, artificial horizon, GPS navigation. The same applies for nautical instruments, in particular a compass, log, sounding device or GPS navigation system, or instruments for diving devices and underwater vehicles, in particular pressure, voltage, current, filling level displays.

Medical instruments are likewise not restricted only to the embodiments described above, and in particular there are also applications in emergency supply and for radiology, for radiotherapeutic, in particular nuclear medical field, and for use on accelerators.

The display device according to the invention may also be used as an instrument for chemical systems, in particular temperature, pressure, filling level, voltage, current or pH meter.

### LIST OF REFERENCES

1 embodiment of the display device
2 embodiment of the fiber-optic arrangement
3 entry face
4 exit face
5 fiber
6 fiber
7 fiber
8 fiber
9 fiber
10 analog and/or digital display
11 housing element
12 housing element
13 lighting means
14 mask
15 window
16 window
17 normal to the exit face
18 image field of the display 10
19 non-round fiber
20 non-round fiber
21 non-round fiber
22 non-round fiber
23 absorbing fiber
24 side face of the pyramidal exit face
25 side face of the pyramidal exit face
26 part of the image field 18 assigned to the side face 24
27 part of the image field 18 assigned to the side face 25
28 housing edge of 11
29 housing edge of 12
30 fastening element, external screw thread
31 internal screw thread
32 annular shoulder
33 O-ring, washer ring
34 recess
35 cavity of the liquid crystal display
36 liquid crystal display
37 electrode
38 electrode
39 electrode
40 electrode
41 electrode
42 cavity
43 cavity
44 cavity
45 cavity
46 cavity
47 cavity
48 plasma display
49 electrode
50 electrode
51 electrode
52 electrode
53 electrode
54 electrode
55 medical instrument
56 handle
57 head
58 light exit opening
59 tooth
60 medical instrument
61 high-intensity light beam
62 tissue to be treated
65 scattering disk
67 light-scattering structures

1. A display device having a fiber-optic arrangement which transmits light from an entry face into an exit face,
wherein regions of an image field lying in front of the entry face are visible on the exit face of the fiber-optic arrangement,
and regions visible on the exit face are spatially offset relative to the image field at least by an offset V, wherein the fiber-optic arrangement comprises a fiber-optic Plate having a first multiplicity of light-transmitting fibers essentially arranged mutually parallel,
characterized by
an image field having a smallest structure size S,
having a distance L between the entry face of the transparent arrangement and the image field, wherein the fiber core diameter of a plurality or all of the transmitting fibers is d,
the plurality or all of the transmitting fibers have a numerical aperture NAₑ on the entry face of the fiber-optic arrangement, and the distance L satisfies the following:
L≦(S−d)/(2·tan [arcsin(NAe)]).

2. (canceled)

3. The display device as claimed in claim 1, wherein the core diameter of a plurality or all of the optical fibers of the first multiplicity of fibers
is greater than or equal to 2 μm.

4. The display device as claimed in claim 1, wherein the numerical aperture NAa of a transparent fiber has the value 1.0 on its exit face.

5. The display device as claimed in claim 1, wherein the numerical aperture NAa of a transparent fiber has a value of approximately 0.7+/−0.3 on its exit face.

6. The display device as claimed in claim 1, wherein the numerical aperture NA of fibers of the fiber-optic arrangement lies in the range of from 0.3 to 0.7.

7. The display device as claimed in claim 1, wherein light-scattering structures are arranged at or on the exit face.

8. The display device as claimed in claim 7, wherein the exit face is roughened.

9. The transparent arrangement display device as claimed in claim 7, wherein a scattering disc is arranged on the exit face.

10. The display device as claimed in claim 1, wherein a resulting image on the exit face of the fiber-optic arrangement is rotated relative to the image in the image field of the display.

11-12. (canceled)

13. The display device as claimed in claim 1, wherein the fiber-optic arrangement comprises a second multiplicity of light-absorbing fibers essentially arranged parallel to the first multiplicity of transmitting fibers.

14-19. (canceled)

20. The display device as claimed in claim 1, wherein the fiber end of at least one transmitting fiber has a non-plane shape.

21-24. (canceled)

25. The display device as claimed in claim 1, wherein the exit face of the fiber-optic arrangement defines and at least locally non-plane surface.

26-30. (canceled)

31. The display device as claimed in claim 1, wherein the offset V at least in a side section of the exit face of the fiber-optic arrangement corresponds approximately to the distance from an edge section of the image field of a display or its display members to a housing edge, neighboring the fiber-optic arrangement, of a housing of the display device.

32. The display device as claimed in claim 1, wherein the offset V relative to the width or the diameter of the fiber-optic plate is more than 0.01 times the width or the diameter.

33. The display device as claimed in claim 1, wherein the offset V relative to the width or the diameter of the fiber-optic plate is less than 3 times the width or the diameter.

34-35. (canceled)

36. The display device as claimed in claim 1, wherein, for a maximum observation angle β of the display device, the numerical aperture of a fiber on its exit face NAa is designed so that NAa=cos(β) is satisfied, where β is the angle as measured from a normal to the exit face at the position of the fiber core to the direction of the observation.

37. The display device as claimed in claim 1, wherein the numerical aperture of a transparent fiber on its entry face NAe corresponds approximately to the numerical aperture of the fiber on its exit face NAa.

38. The display device as claimed in claim 1, wherein the fiber-optic arrangement is part of an imaging device.

39. The display device as claimed in claim 1, wherein the fiber-optic arrangement is part of the cavity of an LCD display and conductive structures or thin-film transistors are arranged on its entry face.

40. The display device as claimed in claim 38, wherein the fiber-optic arrangement is part of the cavity of a plasma display.

41. A motor vehicle instrument comprising a display device having the features of claim 1.

42. An avionics instrument comprising a display device having the features of claim 1.

43. A nautical instrument comprising a display device having the features of claim 1.

44. A nautical instrument, for diving devices or underwater vehicles, comprising a display device having the features of claim 1.

45. A medical instrument for emergency supply, for radiology, for the radiotherapeutic medical field, or for use on accelerators, comprising a display device having the features of claim 1.

46. A medical instrument having a light source for the curing of implants and laser scalpel comprising a display device having the features of claim 1.

47. A medical instrument having a light source for phototherapy, comprising a display device having the features of claim 1.

48. A medical instrument having a light source for heat therapy comprising a display device having the features of claim 1.

49. An instrument for chemical systems, comprising a display device having the features of claim 1.
